(19) United States
(12) Patent Application Publication
(10) Pub. No.: US 2002/0194915 A1
(43) Pub. Date: Dec. 26, 2002

(54) System and method for conditioned based monitoring using acoustic diagnosis

(76) Inventors: Aiman Albert Abdel-Malek, Erie, PA (US); Robert A. Hedeen, Clifton Park, NY (US); Larry R. Handler, Erie, PA (US); Robert D. Cryer, Erie, PA (US); Cecil M. Daniel, Erie, PA (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/158,750

(22) Filed: May 30, 2002

Related U.S. Application Data
(60) Provisional application No. 60/294,354, filed on May 30, 2001.

(51) Int. Cl. G01N 29/00

(52) U.S. Cl. 73/587

(57) ABSTRACT

The present invention is for a system (11) or method for conditioned based monitoring of an assembly (12). The system (11) comprises a sensor (13) placed in proximity to an assembly (12). The sensor (13) generates a signal indicative of the amplitude and frequency of the ultrasonic output of the assembly (12). A processor (14) in communication with the sensor (13) receives the signal from the sensor (13) and generates spectral data representative of the ultrasound emanating from the assembly. A database (15) comprises data representative of operating parameters of the assembly (12). The processor (15) compares the spectral data to the operating parameters and generates a signal indication of the condition of the assembly (12).

Applicant herein claims priority to the Provisional Patent Application, U.S. Serial No. 60/294,354, filed on May 30, 2001.

### FIELD OF THE INVENTION

The present invention relates generally to systems and methods for condition-based monitoring of machines. More specifically, the present invention pertains to the acoustic diagnosis of component parts of complex equipment using ultrasonic sensors.

### BACKGROUND OF THE INVENTION

In conducting a condition-based maintenance (CBM) program for machines, such as transportation machines as locomotives or other mobile assets, a single analyst using physical evaluation and a knowledge base, or database, can make a decision on the relative health of various components of the machine. One method and system of analysis of an operating condition of a piece of component utilizes the acoustic analysis of a piece of equipment or component thereof.

The current methods of acoustic diagnostics are inherently subjective. Ultrasonic sensors typically include a detector, headphones and an amplifier which are available from CTRL Systems, Inc., located in Westminster, Md., USA. An operator manually surveys a piece of equipment by holding the detector adjacent to the equipment and listens for ultrasonic aberrations. The operator is typically trained to interpret aberrations from the normal ultrasonic output of a piece of operating equipment. An alter in the pitch or volume, or a previously undetected sound, may indicate a problem in the operation of the equipment, thereby signaling maintenance for the equipment.

However, such a system does not take full advantage of the diagnostic capabilities of ultrasonic sensors or detection systems. Manual monitoring is subject to individual operators subjective opinion, and does not utilize a database of measurements from which equipment-operating parameters may be measured. Each operator may interpret sounds differently leading to inconsistent or even improper diagnoses, which may result in unnecessarily shutting down the equipment for inspection. Downtime for the equipment translates into lost operating time and under-utilization of equipment.

### BRIEF DESCRIPTION OF THE INVENTION

The present invention is for a method and system for monitoring the condition of a piece of operating equipment (hereinafter referred to as an “assembly”) by analyzing spectral data that is representative of the ultrasonic output of the operating assembly. The terms ultrasound or ultrasonic output as used in this disclosure of the present invention comprises that sound energy that is not within human hearing range and having a frequency of about 20,000 Hz or above.

The system generally includes at least one ultrasonic sensor, placed in proximity to the assembly. The sensor generates a signal indicative of the ultrasound emanating from the assembly. A processor, in communication with the sensor, receives the signals generated by the sensor, and generates spectral data representative of the ultrasonic output of the assembly with respect to the time, frequency and/or amplitude.

A database, in communication with the processor, comprises spectral data (also referred to as “waveforms”) representative of operating parameters of the assembly. The different operating parameters may comprise, for example, normal operating conditions, incipient failures, or assembly failures. In an exemplary embodiment, the database may include spectral data associated with individual components of the assembly in order to identify faults or failure modes of assembly components.

The processor is programmed to analyze the spectral data and generate an output categorizing the condition of the assembly and/or its components, and providing recommendations concerning maintenance. The processor may implement an algorithm that compares spectral data comprising the database associated with the operating parameters of the assembly to spectral data representative of the ultrasonic output of the assembly. The spectral data comprising the database may be generated from an acoustic analysis of the assembly being monitored, or from a population of like assemblies.

Peaks that appear on a spectrum that deviate from a spectrum “baseline” may be indicative of a specific operating parameter, such as an incipient failure or an assembly failure. The “baseline” spectrum represents a normal operating condition of the assembly. In addition, a “baseline” spectrum may be provided for components of the assembly. For example, frequencies at which amplitudes exceed a predetermined amplitude threshold, or are within a predetermined frequency range are compared to the “baseline” in order to evaluate a condition of the assembly. If the amplitude or frequency exceeds a predetermined threshold, or falls within the predetermined range, may be indicative of insipient failure mode of the assembly or a component thereof.

The system may be used to analyze an assembly that is a component of complex of machinery such as large pieces of construction equipment, locomotives or trucks. The sensors may be positioned proximal to a “stationary” operating assembly for detecting ultrasound emanating from the assembly, or the sensors may be positioned proximal to a path of travel of a vehicle for the non-contact detection of ultrasound emanating from the vehicle. In addition the system may comprise an array of sensors proximal to the assembly or vehicle, wherein each sensor of the array of sensor, is positioned to cover a predefined area of the vehicle from which ultrasound may emanate. In this manner, the system may conduct an acoustical diagnosis over the entire vehicle by simultaneously analyzing different components and/or subsystems of the vehicle.

### BRIEF DESCRIPTION OF THE DRAWINGS

FIG. 1 is a schematic illustrating the present invention for the system.

FIG. 2 is a first spectrum representative of a normal operating condition of an assembly plotted by frequency vs. time.

FIG. 3 is a second spectrum representative of a normal operating condition of an assembly plotted by amplitude vs. time.

FIG. 4. is a spectrum illustrating a defect in the condition of an operating assembly.

FIG. 5 is a schematic illustrating an exemplary second embodiment of the invention.

FIG. 6 is a schematic illustrating an exemplary third embodiment of the invention.

FIG. 7 is a flow chart of an embodiment of the method.

### DETAILED DESCRIPTION OF THE DRAWINGS

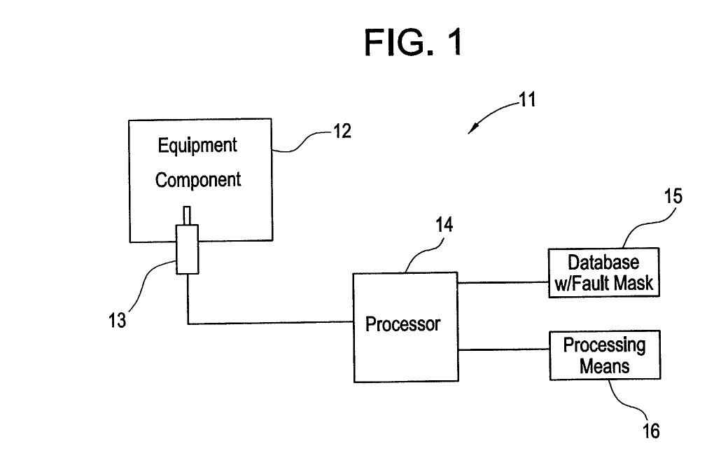

The present invention for a system and method for the condition-based monitoring of an assembly provides the analysis of spectral data representative of the ultrasonic energy emanating from an operating assembly. With respect to FIG. 1, a schematic illustrates the system 11 for the present invention, which includes a ultrasonic sensor 13, placed in proximity to the assembly 12. The sensor 13 is capable of generating a signal that is indicative of the ultrasound output of assembly 12. Such a sensor may include a UL101 device sold by CTRL Systems, Inc. located in Westminster, Md., USA.

The sensor 13 is integrated with a processor 14, which receives the signal from the sensor 13 and converts the signal into spectral data illustrative of the ultrasound emanating from the assembly. The processor 14 may be a typical personal computer and monitor having sufficient memory capacity, and is programmed to display a spectrum, and to interpret and analyze spectral data. The processor 14 may also include networking capabilities to receive or transmit data to remote locations as necessary. The processor 14 provides access to a database 15 for the analysis of the spectral data by a processing means 16.

The above-described components for the present invention of the system operate to provide for the analysis of ultrasonic characteristics of assemblies. A description of the operation of these components and the system is provided below. In operation of the present invention, spectral data obtained from an operating assembly 12 is compared to data stored within a database 15 that is representative of the ultrasound associated with the operating parameters of the assembly 12 being monitored, or of a selected population of like assemblies.

The spectral data maintained in the database 15, or generated from monitoring the assembly, may be plotted using any combination of three coordinates including time, frequency or amplitude. The spectral data may be mapped either in a two-dimensional or three-dimensional format. The different operating parameters may comprise for example spectral data representative of the normal operating condition of the assembly, one or more incipient failures or one or more assembly failures. The incipient failures or full failures may be associated with specific fault characteristics of this assembly that appear within some predetermined range, or exceed some predetermined threshold, measured by frequency, time or amplitude.

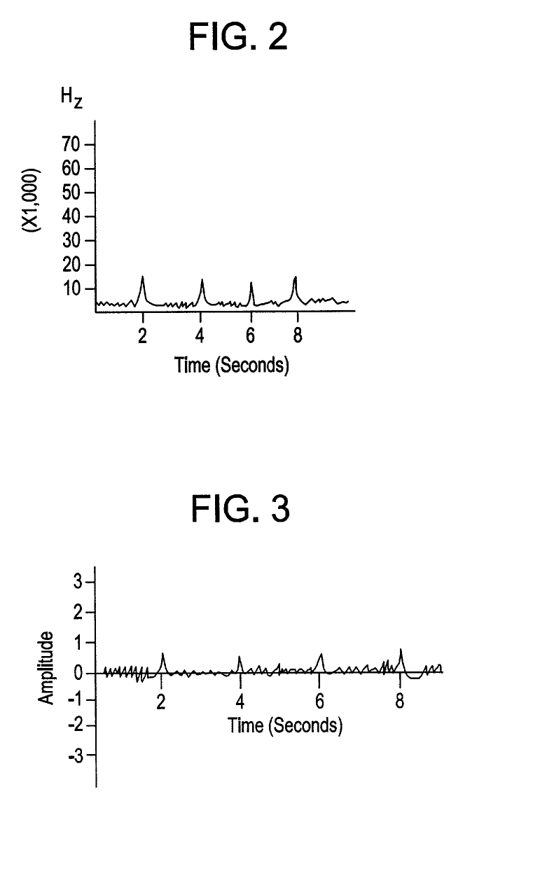

With respect to FIG. 2, a spectrum is shown that is representative of the normal operating condition of the assembly 12, and plots frequency versus time. A spectrum indicative of a normal operating condition serves as a “baseline” spectrum and may comprise for example any peak appearing at or below a predetermined frequency, within predetermined timed durations. The particular spectrum illustrated in FIG. 2, does not display any outstanding peaks. In comparison, the waveform illustrated in FIG. 3, contains outstanding peaks appearing on a regular periodic basis; however, such peaks fall below a predetermined amplitude threshold that is indicative of a normal operating condition of the assembly. Similarly, a sinusoidal waveform may be consistent with the normal operating condition of the assembly 12.

An assembly 12 that experiences a failure, or is leading to a failure, may generate ultrasound that is indicative of the specific failure, or the assembly's tendency of failure. Accordingly, the ultrasound may be detected and digitized to generate a waveform that is indicative of the assembly failure. The database 15 may comprise spectral data such that ultrasound producing a waveform having any peak appearing above a predetermined amplitude or frequency may indicate that the assembly is experiencing some abnormality and should be serviced to identify the problem, and/or correct such problem.

Spectra may be utilized to more specifically identify failures in the assembly 12. A spectrum having peaks appearing within some predetermined time or frequency, and/or above some minimum frequency or amplitude respectively may be associated with a specific failure of an assembly 12. Or peaks appearing at a predetermined time above a minimum frequency, or within a predetermined frequency, may be indicative of a failure of the assembly 12. For example, a peak appearing within a predetermined range of frequencies from about 40,000 Hz to about 70,000 Hz above some predetermined amplitude may indicate a clogged fuel injector. Sound may be the result of valves not opening or the timing of the actuation of the valves is interrupted.

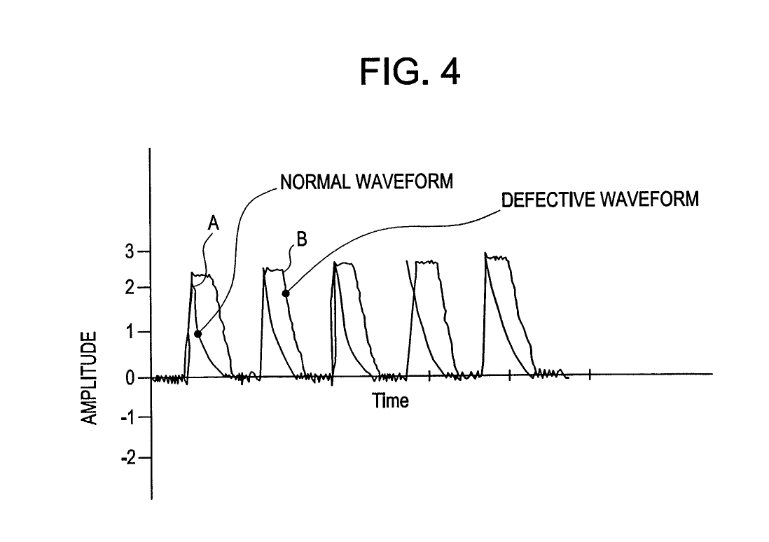

Similarly the shape of a peak may be considered in analyzing the condition of the assembly 12. With respect to FIG. 4, superimposed spectra are shown to illustrate detection of an assembly failure based on the shape of peak. As shown in FIG. 4, the spectra includes peaks A, recurring periodically at discrete time intervals and, indicative of a normal condition of the assembly 12. The peaks B have the same amplitude as Peaks A, but the peaks B are much broader in shape. The broader shape, with respect to the spectrum of FIG. 4, indicates detection of a higher frequency at these time intervals, which may be indicative of an assembly failure, or incipient failure of the assembly or component thereof.

Once the spectra have been analyzed, the processor 14 generates a signal to provide a recommendation for any maintenance action if necessary. The condition based monitoring of assemblies is particularly advantageous with respect to predicting failures in an assembly or its components. For example, the database is able to identify an incipient failure of the assembly 12, and based on either statistical or an empirical study of the assembly, or a population of like assemblies from which the assembly is selected, the processor 14 is able to predict a remaining life span of the assembly, or its components, and when maintenance should be scheduled to maximize the use of the assembly 12.

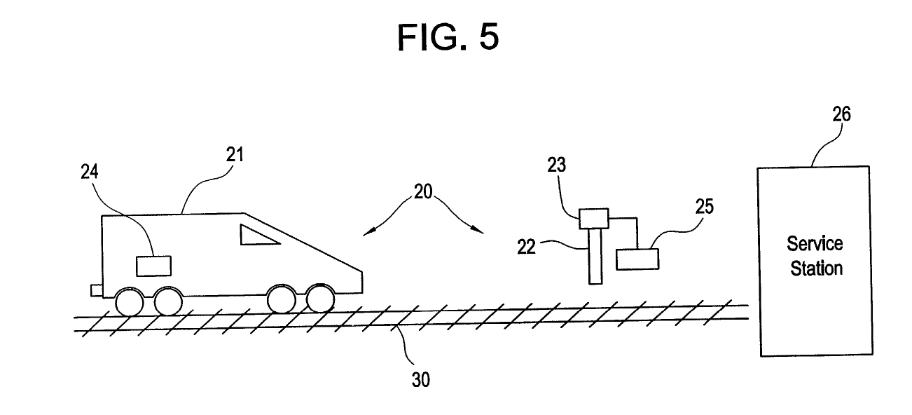

An embodiment of the system 20 is shown in the schematic with respect to FIG. 5, in which the invention is utilized for acoustic diagnosis of a vehicle 21 and/or its components 24. Although primarily illustrated and described with respect to a mobile asset such as a locomotive or fleet of locomotives, the present invention is not so limited and may be used in connection with for example trucks, heavy operating equipment such as loading cranes, excavation equipment, and shipping equipment such as water-going vessels.

The monitoring system 20 comprises a structure 22, having at least one sensor 23 secured thereon for detection of ultrasound associated with the operation of the vehicle 21. The sensor 23 is placed in communication with a processor 25 for generating a signal indicative of the condition of the vehicle 21. The processor 25 maintains a database 27 of spectral data associated with various operating parameters of the vehicle as described above.

The structure 22 is proximally located to a path 30 of travel of the vehicle 21 and disposes sensors 23 sufficiently close to the vehicle 21 to effectively detect ultrasound emanating from the vehicle 21 and/or component parts 24 thereof. Such a structure may include some type of enclosure, in which sensors 23 are imbedded. In this manner, the structure 22 to some degree can control ambient conditions including wind, temperature and noise that may affect the sensitivity of the sensors 23.

The term “component” as used in this disclosure includes the individual parts of a locomotive, such as turbo bearings, water pump assemblies, wheel bearings etc. The term “component” may also include various subsystems such as the gear train, water coolant system, fuel injection system, bearing assemblies, etc., within the vehicle 21 that comprises a plurality of different parts.

The structure 22 is preferably located adjacent a vehicle service area 26, which provides an opportunity to detect ultrasonic output of the vehicle 21. As the vehicle 21, such as a locomotive, approaches a servicing station 26, the speed of the vehicle 21 may slow to only a few miles per hour. At such a speed, the sensors 23 may effectively detect physical phenomena emanating from the vehicle 21 and or components 24 of the vehicle.

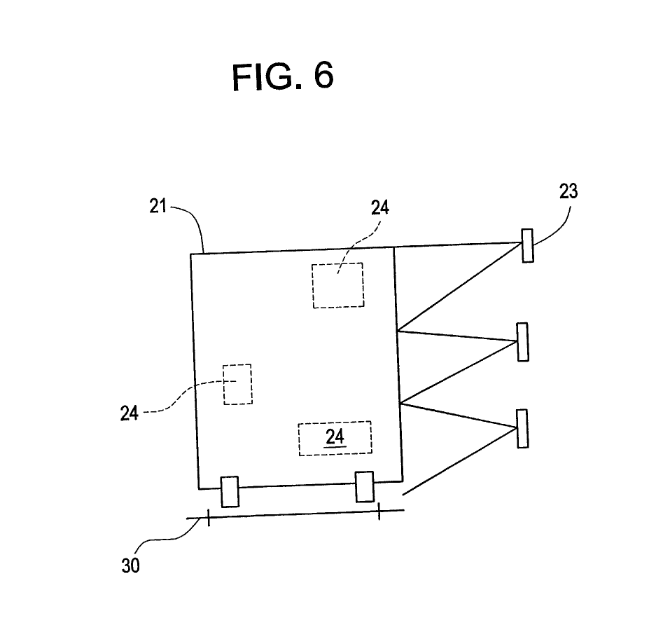

An exemplary embodiment may comprise an array of sensors 23, as shown in FIG. 6. The sensors 23 are optimally positioned along the structure 22 to detect ultrasound output. The sensors 23 may be disposed at elevations corresponding to the location of certain components 24 from which these physical phenomena may emanate. Once a sensor 23 is activated, or begins detection of the physical phenomenon, the processor is able to immediately identify the component 24 as generating the signal from the sensor 23. However the sensors 23 do not have to correspond to any particular component 24, but may be positioned to optimize detection of physical phenomenon generated from any location on the vehicle 21, or a predefined are of the vehicle as it passes the sensor 23. And, as will be explained in more detail below, the processor 25 is capable of identifying a particular component 24 from which the ultrasound is generated.

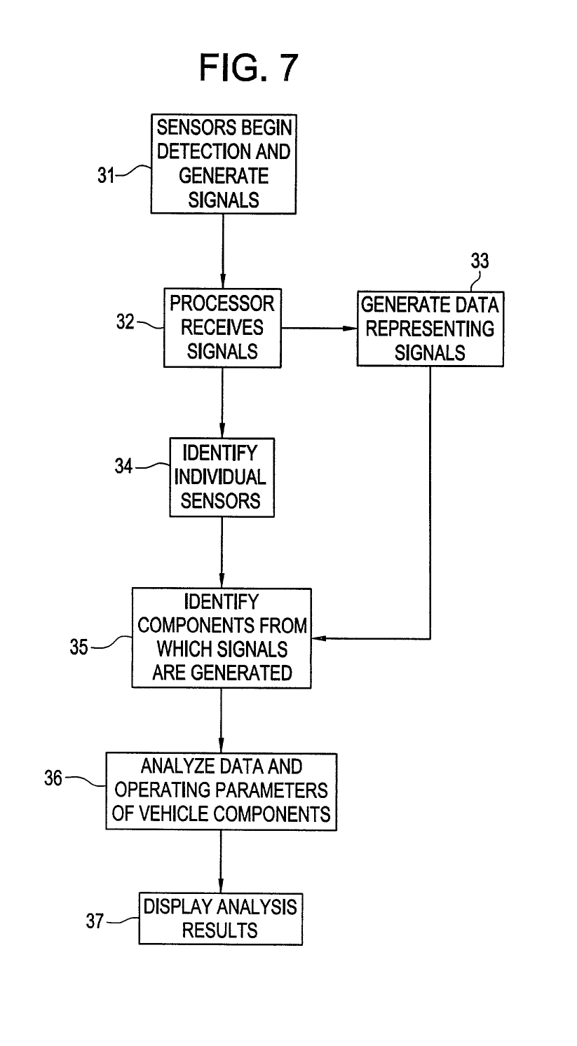

A method for the invention is referenced with respect to FIGS. 7. Steps 31 and 32, as the vehicle 21 passes the frame structure 22, the sensors 23 detect ultrasounds emanating from the vehicle 21 and generate a signal to be associated with an operating parameter of the vehicle 21. The signal is transmitted to, and received by, the processor 25.

In step 32, the processor 25 collects data by digitizing the signals and generates data, usually in a waveform having frequency, amplitude and/or time. In order to analyze collected data, the processor 25 must correspond the data to a particular vehicle component 14. In steps (Blocks 34 and 35), the processor 25 identifies the sensor 23 detecting the ultrasound, and then identifies the components 24 generating the phenomena. In this manner, the processor 25 is capable of comparing the generated data to historical data representing operating parameters of the components 24 and vehicle 21.

The database 27 may contain a geometric configuration of the vehicle, including its various components 24. The geometric configuration may be that of a vehicle 21 representative of a group of vehicles within a fleet of mobile assets, or a configuration may exist for each individual vehicle 21 that passes the structure 22. The geometric configuration comprises the identification and location of various components 24 on the vehicles 21. A vehicle 21 may be assigned an identification number, which corresponds to a geometric configuration representative of that vehicle 21, or a group of vehicles.

In an exemplary embodiment, the processor 25 comprises historical spectral data relating to a specific areas or components 24 on the vehicle 21. A spatial map may be generated from the historical spectral data of the vehicle which map provides a spatial coordinate, including the location of parts along longitudinal and elevational axes of the vehicle. The spectral data comprises coordinates of frequency and spatial coordinates (x, y). The spectral data also includes waveforms, which similarly provide a print of the vehicle and its components 24.

As represented in steps 36 and 37, the data received from sensors is compared to the historical data and/or geometric configuration to identify the components 24 associated with the detected phenomena.

In another embodiment, the processor may integrate an algorithm by which a location of component or subsystem may be calculated within the vehicle, using the rate of speed by which the vehicle passes a certain sensor. For example, a vehicle traveling a rate of 5 miles per hour may activate a locating sensor (not shown), which corresponds to a location on the vehicle 21 at the front of the vehicle 21. When a sensor 23 detects a physical phenomenon 2 seconds after the location sensor is activated, a vehicle 11 that is 100 feet long traveling at 5 miles per hour places the subsystem 24 from which physical phenomena is emanated at approximately 16 feet from the front of the vehicle.

The database 27 may contain various operating parameters within which components effectively operate, including providing data representative of normal operation of a component, incipient failure conditions, or condemning limits (“assembly failures”) at which limits may indicate failure of the component parts. The processor 25 is programmed to implement at least one or more algorithms that compare data obtained from the sensors 23 to the historical data within the database 32 of the processor 25. Based on a comparison of the collected data to the historical data, the processor 25 generates a signal that is indicative of a condition of the vehicle and/or component part. The results of this analysis may be presented or placed in a variety of forms, including a general health indicator of the different vehicle components or subsystems; flagging certain components with impending or imminent failures; and recommending corrective actions. The display 26 of the recommended actions can be displayed on a link with the processor 25 and/or sensor 23 as part of the structure 22 or on a repair kiosk at the fueling or service stations 25 Similarly, remote displays may be available through an information communication network, so that users at various remote locations may review information or data made available on a particular vehicle passing by or through the frame structure and sensors.

While the invention has been described in what is presently considered to be a preferred embodiment, many variations and modifications will become apparent to those skilled in the art. Accordingly, it is intended that the invention not be limited to the specific illustrative embodiment but be interpreted within the full spirit and scope of the appended claims.

We claim as our invention:

1. A system for monitoring the condition of assembly subject to producing ultrasound associated with an operating condition of the assembly, the system comprising:
(a) a sensor, proximal to the assembly, for detecting ultrasound emanating from the assembly and capable of generating signals indicative of said ultrasound;
(b) a processor, in communication with the sensor, for receiving the signals generated by the sensor and generating spectral data representative of the ultrasound emanating from the assembly, with respect to a frequency or amplitude of said ultrasound;
(c) a database, in communication with the processor, comprising spectral data representative of at least one operating parameter of the assembly; and,
(d) said processor comparing said spectral data, representative of the ultrasound emanating from the assembly, and the data representative of the operating parameter of the assembly, and generating a signal indicative of the condition of the assembly.

2. The system of claim 1 wherein said database further comprises at least one spectrum with respect to time representative of a normal operating condition of the assembly.

3. The system of claim 2 wherein said normal operating condition is represented by a spectrum below a maximum frequency or amplitude and within a predetermined timed duration.

4. The system of claim 1 wherein said database further comprises at least one spectrum, with respect to time, representative of at least one incipient failure of the assembly.

5. The system of claim 4 wherein said least one incipient failure is represented by a spectrum having a peak exceeding a minimum frequency or amplitude within a predetermined timed duration.

6. The system of claim 1 wherein said database further comprises at least one spectrum, with respect to time, representative of at least one failure mode of the assembly.

7. The system of claim 3 wherein said least failure mode is represented by a spectrum having a peak exceeding a minimum frequency or amplitude within a predetermined timed duration.

8. The system of claim 1 wherein said spectral data representing at least one operating parameter of the assembly is obtained from an analysis of spectral data representative of the ultrasonic output of a population of like assemblies.

9. A method for monitoring the condition of an assembly, comprising the steps of:
(a) providing spectral data, with respect to amplitude or frequency, associated with at least one operating parameter of said assembly;
(b) collecting spectral data that is indicative of the amplitude or frequency of the ultrasonic output of the assembly;
(c) comparing the collected spectral data to the operating parameter spectral data; and,
(d) generating a signal responsive to the comparison of the spectral data and said signal is indicative of a condition of the assembly.

10. The method of claim 10 further comprising the step of providing at least one spectrum with respect to time corresponding to a normal operating condition of the assembly.

11. The method of claim 10 wherein said normal operating condition is represented by a spectrum below a maximum frequency or amplitude within a predetermined timed duration.

12. The method system of claim 9 further comprising the step of providing at least one spectrum, with respect to time, representative of at least one incipient failure of the assembly.

13. The method of claim 12 wherein said least one incipient failure comprises represented by a spectrum having a peak exceeding a minimum frequency or amplitude within a predetermined timed duration.

14. The method of claim 9 further comprising the step of providing at least one spectrum, with respect to time, representative of at least one failure mode of the assembly.

15. The method of claim 14 wherein said least failure mode comprises represented by a spectrum having a peak exceeding a minimum frequency or amplitude within a predetermined timed duration.

16. The method of claim 9 further comprising the step of generating said historical spectral data, representing at least one operating parameter of the assembly, from an analysis of spectral data representative of the ultrasonic output of a population of like assemblies.
